(19) United States
(12) Patent Application Publication
(10) Pub. No.: US 2017/0210598 A1
(43) Pub. Date: Jul. 27, 2017

(54) ELEVATOR SYSTEM

(71) Applicants: ThyssenKrupp Elevator AG, Essen (DE); ThyssenKrupp AG, Essen (DE)

(72) Inventors: Holger Zerelles, Leinfelden-Echterdingen (DE); Bernd Altenburger, Neuhausen (DE); Ronald Dietze, Böblingen (DE)

(73) Assignees: ThyssenKrupp Elevator AG, Essen (DE); ThyssenKrupp AG, Essen (DE)

(21) Appl. No.: 15/329,187

(22) PCT Filed: Aug. 4, 2015
(86) PCT No.: PCT/EP2015/067976

§ 371 Date: Jan. 25, 2017

(30) Foreign Application Priority Data
Aug. 5, 2014 (DE) 10 2014 011 378.7

(51) Int. Cl. B66B 11/00; B66B 9/00

(52) U.S. Cl. CPC B66B 11/004; B66B 11/0015; B66B 9/00; B66B 11/002; B66B 11/0045

(57) ABSTRACT

An elevator system may have a vertical shaft and at least two cars that are arranged above one another in the shaft and can each be moved upwards and downwards. A first car may be coupled via first suspension means to a first drive and a first counterweight, and a second car may be coupled via second suspension means to a second drive and to a second counterweight, and to a machine room adjacent to the shaft which is spatially separate from the shaft. The first drive is disposed outside the shaft and the second drive is disposed at least partially within the shaft.”

The present invention relates to an elevator system having a vertical shaft and at least two cars which are arranged above one another in the shaft and can each be moved upwards and downwards. In this case, a first car is coupled via first suspension means to a first drive and a first counterweight and a second car is coupled via second suspension means to a second drive and a second counterweight.

Elevator systems of this kind are particularly used in very tall buildings. Compared with a traditional elevator system, they offer the advantage of a greater transportation capacity relative to the surface area used. In order to be able to put this capacity to the best possible use, it is desirable for the two cars to be capable of being moved independently of one another between the floors of the building (notwithstanding the natural limitation that one of the cars is always above the other one).

In order to achieve this independence of the two cars, they are each provided with their own suspension means and their own drive, as well as associated control elements, etc. The suspension means each comprise at least one suspension rope and at least one counterweight, wherein the arrangement thereof in the shaft can be realized, for example, in that the suspension rope of the upper car engages with the upper side thereof and the suspension rope of the lower car on the underside thereof, as is known from EP 1 565 396 B1, for example.

In traditional elevator systems, the drive is frequently arranged in a machine room which is located above the shaft and is separated therefrom by a floor that can be walked on. This floor allows the machine room to be entered by staff for the purpose of the maintenance and repair of the elevator system, wherein the floor can be created by a grid or by a ceiling of the building concerned or by another suitable structural measure.

In elevators of the kind referred to above with two cars, accommodating the drives is problematic, particularly since relatively large, high-performance drives are required when the elevator system is used in very tall buildings. In elevator systems with a machine room, the area of the machine room is frequently inadequate for the drives of the cars, insofar as it corresponds to the cross-sectional area of the shaft, so that in this case either the machine room is enlarged sideways beyond the cross section of the shaft or two or more machine rooms lying above one another are provided. Both possibilities reduce the useable space in the building, which is generally undesirable.

Against this background, a problem addressed by the present invention is that of improving an elevator system of the kind referred to above, particularly in order to restrict a building's useable space as little as possible.

In order to solve the problem, an elevator system having a vertical shaft and at least two cars which are arranged one above the other in the shaft and can each be moved upwards and downwards, is proposed. A first car in this case is coupled via first suspension means to a first drive and a second drive is coupled via second suspension means to a second drive, wherein the first drive is arranged outside the shaft and the second drive is arranged at least partially within the shaft. The first drive in this case is preferably arranged in a room separated from the shaft. In particular, it is provided according to one embodiment of the elevator system that the first drive is arranged on the roof of the building containing the elevator system.

Advantageously, the first and second drives each comprise a motor, particularly an electric motor, and a traction sheave. The drive may also comprise a gear mechanism according to one variant. The suspension means each comprise at least one suspension rope and at least one counterweight.

According to a particularly preferred embodiment of the elevator system according to the invention, it is provided that the elevator system comprises a machine room adjacent to the shaft, which is spatially separated from the shaft, wherein the first drive is arranged within the machine room. In this embodiment, it is advantageously sufficient for a machine room of the customary size to be provided, as this only has to accommodate one of the drives, while the other drive is arranged completely or at least partially within the shaft, advantageously without the shaft having to be larger in design for this and, in particular, without an increase in the height of the shaft being necessary. The machine room is advantageously accessible, particularly for maintenance and/or repair purposes.

The machine room of the elevator system is preferably adjacent to the upper end of the shaft of the elevator system. In particular, it is provided that the machine room is arranged above the shaft or at the side next to the shaft. According to a further advantageous embodiment, the machine room is arranged above the shaft. In this case, the machine room preferably does not extend beyond the cross section of the shaft, or at least not substantially. In particular, it is provided that no more than 10% of the machine room extends beyond the cross section of the shaft.

The machine room is advantageously separated from the shaft of the elevator system by a delimitation, wherein it is particularly provided that the delimitation comprises recesses or openings, through which suspension ropes of the suspension means, in particular, can be guided. As a further advantageous embodiment of the elevator system according to the invention, it is provided that the machine room of the elevator system is separated from the shaft by a floor that can be walked on and/or a wall. The delimitation between the machine room and the shaft in this case is therefore the floor and/or the wall.

The floor of the machine room may be configured in different ways, particularly as a ceiling or as a false ceiling or as a grating. The decisive factor in this case is that the floor can be walked on and therefore defines the machine room as an independent room which does not belong to the shaft.

The first drive is preferably arranged completely in the machine room. According to an advantageous embodiment, it is further provided that the first drive is arranged partially in the floor which separates the machine room from the shaft. For this purpose, the floor preferably has a corresponding gap or recess.

In a further preferred embodiment of the invention, the second drive is completely arranged in the shaft. In this case, a complete structural separation of the shaft from the machine room is advantageously possible, which can advantageously be realized very simply in structural terms. In particular, the floor of the machine room may be continuous over the entire shaft cross section—apart from the openings which are necessary for the suspension means of the first car.

As a variant to this, however, it is also provided that the second drive is arranged at least partially in a recess, particularly in an opening, in the delimitation between the shaft and the machine room, according to a further embodiment particularly such that the second drive projects partially into the machine room. This variant advantageously offers particularly great flexibility in the arrangement of the second drive, wherein the position thereof can be optimized in such a manner that even with a relatively large drive, neither the upper region of the shaft nor the engine room has to be enlarged.

The machine room must usually also have a minimum height which is defined by technical regulations, in order to allow staff to have ergonomic, safe working during the maintenance and repair of the elevator system.

In many cases, the machine room is arranged above the shaft, wherein it does not then extend beyond the cross section of the shaft in a horizontal direction, or not substantially. This means that the amount of space used in the building can be kept to a minimum. As mentioned above, with the arrangement of two drives in a machine room, an enlargement of with this kind is frequently unavoidable.

The second drive is preferably arranged either within the vertical projection of the cars or outside it; in the second case, therefore, wholly or partially offset to the side in respect of the cars. The choice of position of the second drive means that the available space in the upper end of the shaft is advantageously optimally used. In the first variant, it is advantageously ensured that a sufficient safety distance still remains between the uppermost position of the upper car and the end of the shaft. The second variant advantageously offers the possibility that the cars can run past the second drive, insofar as said drive is located entirely outside the vertical projection. According to an advantageous embodiment of the elevator system according to the invention, it is thereby provided that the second drive is arranged in the shaft positioned completely or partially offset to the side in respect of the first car, such that the first car can at least be moved along part of the second drive.

In particular, it is provided that the second drive is arranged or secured on guide rails provided for the cars or for the counterweights and/or on an inner wall of the shaft and/or on the underside of the floor of the machine room. Corresponding guide rails are advantageously usually present in any event. These are preferably extended upwards, in order to be able to act as a securing means for the second drive.

In an alternative embodiment of the invention, the machine room is arranged at the side next to the shaft, i.e. particularly next to the upper end of the shaft, and is separated therefrom by a wall. In this way, the space requirement of the elevator system can be minimized in the vertical direction. This variant is provided, e.g. when the uppermost floor of the building is also to be served by the elevator and a roof structure for the machine room is undesirable.

According to a further advantageous embodiment, it is provided that the second drive has smaller dimensions than the first drive. In this way, less installation space is advantageously required in the shaft. In the elevator system according to the invention, the first and second drives in many cases exhibit substantially the same drive performance, as the first car and the second car are preferably designed for the same carrying capacity and the same maximum travelling distance. In particular, in order to reduce the dimensions of the second drive, it is provided that one of the cars is designed for lower speeds and therefore requires a smaller drive, for example because this only has to serve a smaller part of the floors of a building. In this case, it is favorable for the second drive, which is arranged at least partially within the shaft, to have a smaller drive output than the first drive, for which there is usually more space available in the machine room.

In addition, control elements are assigned to the first drive and control elements to the second drive. These comprise, in particular, the electronic control system, preferably including the control elements, in addition preferably also elements such as speed limiters and/or frequency converters, etc. As these control elements can usually be positioned very flexibly compared with the drives, it is provided according to an embodiment of the invention that at least the first control elements are arranged within the machine room of the elevator system, particularly preferably all control elements are arranged within the machine room, so particularly also the second control elements for the second drive located in the shaft.

According to a further embodiment of the invention, it is provided that the first control elements are arranged within the machine room and the second control elements within the shaft, i.e. advantageously in spatial proximity to the drive concerned in each case. In this case, it may be particularly advantageous for the second control elements to comprise operating elements which are arranged in the shaft at the level of a portal. This means that during maintenance work on the elevator system, visual contact with the second drive is maintained from the portal. As a further possibility, the second control elements may also be arranged in an area alongside the shaft, i.e. particularly in the area in front of the (uppermost) elevator portal.

These and further advantages of the invention are explained in greater detail with the help of the following exemplary embodiments with reference to the figures.

The figures show in detail:

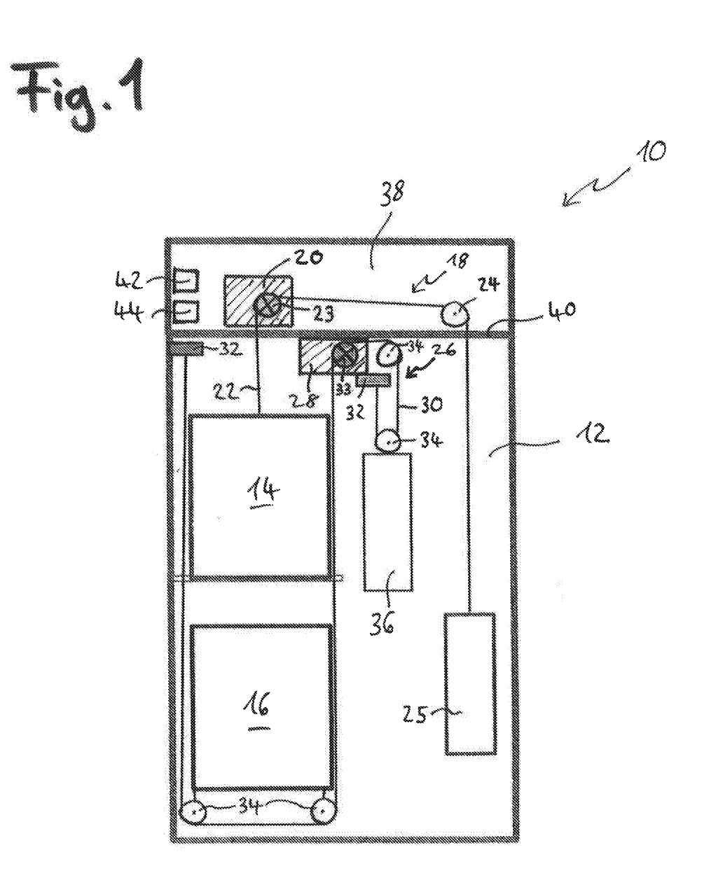

FIG. 1: a schematic representation of a first exemplary embodiment of an elevator system according to the invention;

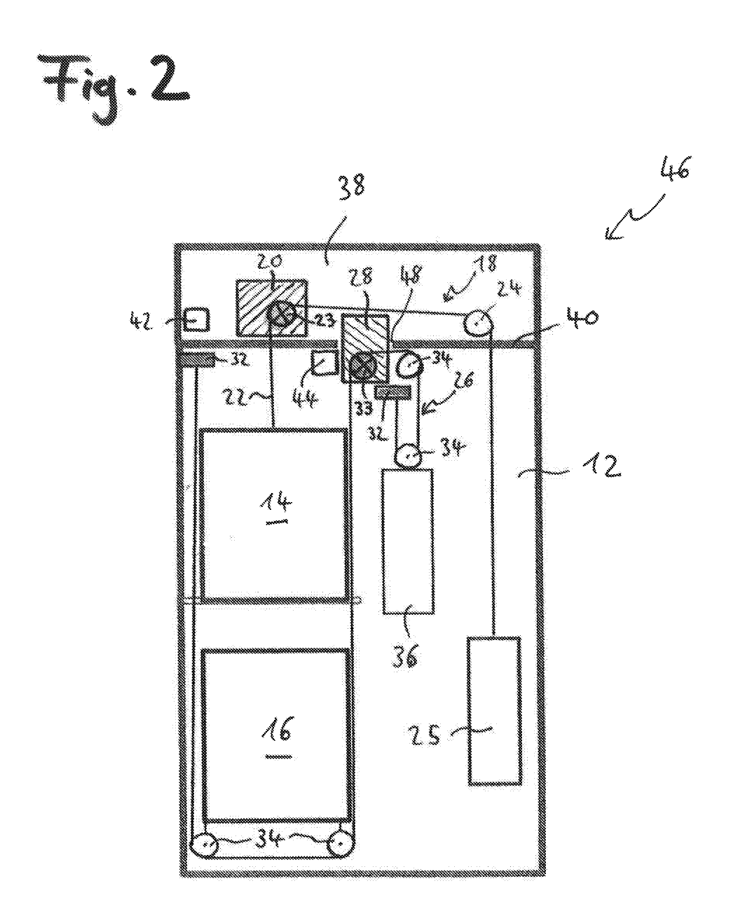

FIG. 2: a schematic representation of a second exemplary embodiment of an elevator system according to the invention; and

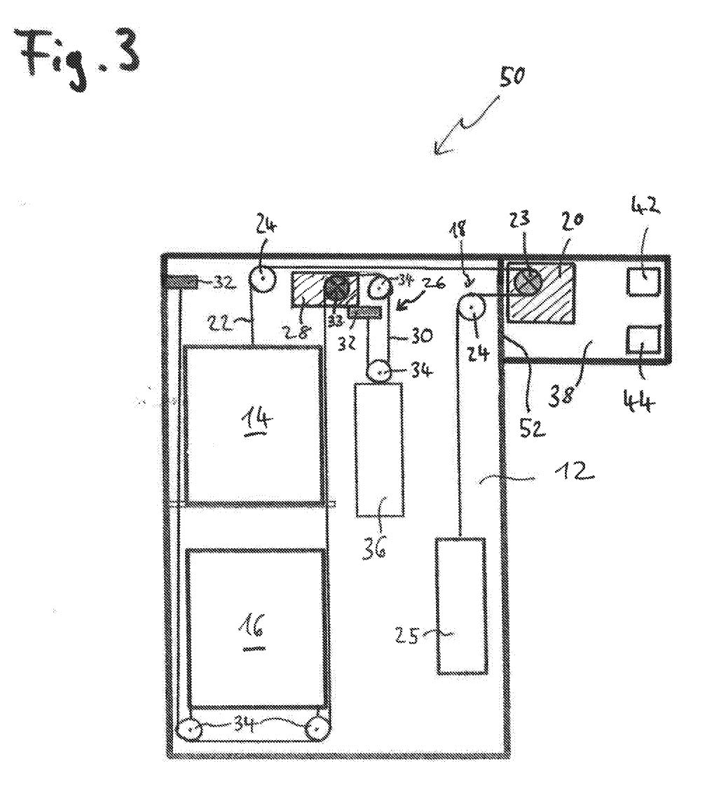

FIG. 3: a schematic representation of a third exemplary embodiment of an elevator system according to the invention.

FIG. 1 shows a first exemplary embodiment of an elevator system according to the invention which is referred to as a whole as 10. Only the substantial components of the elevator system 10 are depicted, namely purely schematically without taking account of the actual size relationships.

The elevator system 10 comprises a vertical shaft 12, in which a first car 14 and a second car 16 are arranged one above the other. The two cars 14 and 16 can be moved substantially independently of one another upwards and downwards in the shaft 12, wherein the first car 14 is always located above the second car 16.

The first car 14 is coupled via first suspension means 18 to a first drive 20, as is schematically depicted in FIG. 1. The first suspension means 18 comprise a suspension rope 22 which engages on the upper side of the first car 14 and leads via the traction sheave 23 of the drive 20 and a deflection roller 24 to a counterweight 25.

The second car 16 is coupled via second suspension means 26 to a second drive 28, as shown schematically in FIG. 1. The second suspension means 26 comprise a suspension rope 30, the ends whereof are fastened to two fixing points 32 in the shaft 12. The suspension rope 30 runs via the traction sheave 33 of the drive 28 and a total of four deflection rollers 34, two of which are secured to the underside of the second car 16 and one to a counterweight 36.

In this exemplary embodiment, the first car 14 therefore has a so-called one-to-one suspension and the second car 16 has a two-to-two suspension. However, this is only by way of example and other suspensions or combinations of suspensions can be chosen within the framework of the present invention.

Arranged above the shaft 12 is a machine room 38 adjacent to the shaft 12, which machine room is separated from the shaft 12 by a floor 40 that can be walked on. The floor 40 is depicted in FIG. 1 as a solid floor. This may, in particular, be a ceiling, but likewise a grate can also act as a floor 40 that can be walked on.

The machine room 38 in this exemplary embodiment is used to receive the first drive 20 which is arranged entirely within the machine room 38. The drive 20 comprises an electric motor which drives the traction sheave 23, via which the suspension rope 22 of the first suspension means 18 runs, either directly or via a gear mechanism. The suspension rope 22 in this case runs via openings in the floor 40 of the machine room 38.

The second drive 28 in the elevator system 10 is arranged outside the machine room 38, namely completely within the shaft 12. Specifically, the second drive 28 in this example is located partially within the vertical projection of the cars 14 and 16 a partially offset to the side, in order to put the existing space to optimum use. Depending on the spatial circumstances, an arrangement entirely within or entirely outside the vertical projection of the cars 14 and 16 may also be more advantageous. The drive 28 runs the traction sheave 33 directly or indirectly via which the suspension rope 30 of the second suspension means 26 runs.

The drive 28 may be secured in the position shown either on the underside of the floor 40 or the inside wall of the shaft 12, particularly also on guide rails (not shown in the figure) for the cars 14 and 16 or the counterweights 25 and 26.

The arrangement of the two drives 20 and 28 within the elevator system 10 is very efficient and space-saving, as the machine room 38 must only hold one drive 20. It may therefore be designed with a standard size which does not extend beyond the cross section of the shaft 12 in the horizontal direction and is not higher than the minimum height prescribed or necessary for entering the machine room for maintenance and repairs in the vertical direction. For the second drive 28, the space available in the upper end of the shaft 12 is used, wherein a certain safety distance above the uppermost position of the first car 14 is observed.

The elevator system 10 further comprises first control elements 42 which are assigned to the first drive 20 and also second control elements 44 which are assigned to the second drive 28. The control elements 42 and 44 particularly comprise the actual electronic control system for the movement of the cars 14 and 16, including operating elements, and also speed limiters, frequency converters, etc.

In this exemplary embodiment, both the first and also the second control elements 42 and 44 are arranged in the machine room 38, as there is space for them there on account of their smaller size compared with the drives 20 and 28. Alternatively, the second control elements 44 may also be arranged in the shaft 12, i.e. in spatial proximity to the second drive 28.

A second exemplary embodiment of an elevator system according to the invention, which is referred to as a whole as 46, is depicted schematically in FIG. 2. The elevator system 46 corresponds to the elevator system 10 according to the first exemplary embodiment, except for the differences described below. Identical elements or those corresponding to one another in FIGS. 1 and 2 are each provided with the same reference numbers.

In the elevator system 46, the second drive 28 is not completely located within the shaft 12, but it is partially arranged in a recess 48, namely an opening, in the floor 40 of the machine room 38 and projects into the machine room 38. This means that the second drive 28 takes up less space in the shaft 12 than in the first exemplary embodiment, so that in this case the minimum distance between the first car 14 and the floor 40 can be reduced. At the same time, the second drive 28 in this case requires a certain amount of space in the machine room 38, but not so much that said machine room has to be enlarged.

In the elevator system 46, the first control elements 42 are arranged in the machine room 38 and the second control elements 44 in the shaft 12, so in each case in spatial proximity to the respective drive 20 or 28. It is also alternatively possible in this exemplary embodiment, however, for all control elements 42 and 44 to be arranged in the machine room 38, as in the elevator system 10 according to the exemplary embodiment explained in connection with FIG. 1.

FIG. 3 shows schematically a further exemplary embodiment of an elevator system according to the invention which is referred to as a whole as 50. The elevator system 50 likewise corresponds to the elevator system 10 according to the first exemplary embodiment, except for the differences described below. The same elements or elements corresponding to one another are each provided with the same reference numbers in FIGS. 1 and 3.

The machine room 38, in which the first drive 20 for the first car 14 is arranged, is not located above, but to the side next to the upper end of the shaft 12 in this exemplary embodiment. The machine room 38 in this case is separated from the shaft 12 by a wall 52. The suspension rope 22 in this case runs via the traction sheave 23 and two deflection rollers 24.

Although the arrangement of the machine room 38 on the side means that the horizontal space requirement in this region is greater, on the other side, however, the vertical space requirement of the elevator system 50 can be minimized. This variant is appropriate, e.g. when the uppermost floor of the building is also to be served by the elevator and a roof structure for the machine room is undesirable.

The first and second control elements 42 and 44 are all arranged in the machine room 38 in this exemplary embodiment, wherein it is alternatively possible here, too, for the second control elements 44 to be arranged in the shaft 12.

### LIST OF REFERENCE NUMBERS

10 elevator system
12 shaft
14 first car
16 second car
18 first suspension means
20 first drive
22 suspension rope
23 traction sheave
24 deflection rollers
25 counterweight
26 second suspension means
28 second drive
30 suspension rope
32 fixing points
33 traction sheave
34 deflection rollers
36 counterweight
38 machine room
40 floor
42 first control elements
44 second control elements
46 elevator system
48 recess
50 elevator system
52 wall

1.-15. (canceled)

16. An elevator system comprising:
a first car that is disposed in a vertical shaft and is movable upwards and downwards, with the first car being coupled via first suspension means to a first drive; and
a second car that is disposed in the vertical shaft and is movable upwards and downwards, wherein the first and second cars are arranged one above another in the vertical shaft, with the second car being coupled via second suspension means to a second drive, wherein the first drive is disposed outside the vertical shaft and the second drive is disposed at least partially within the vertical shaft.

17. The elevator system of claim 16 further comprising a machine room adjacent to the vertical shaft but spatially separated from the vertical shaft, wherein the first drive is disposed within the machine room.

18. The elevator system of claim 17 wherein the machine room is adjacent to an upper end of the vertical shaft.

19. The elevator system of claim 17 wherein the machine room is disposed above the vertical shaft or at a side next to the vertical shaft.

20. The elevator system of claim 17 wherein the first drive is partially disposed in a floor that separates the machine room from the vertical shaft.

21. The elevator system of claim 17 wherein the second drive is disposed at least partially in a recess in a delimitation between the vertical shaft and the machine room.

22. The elevator system of claim 17 wherein the second drive is disposed on at least one of guide rails provided for the first and second cars or for counterweights, on an inner wall of the vertical shaft, or on an underside of a floor of the machine room.

23. The elevator system of claim 17 further comprising first control elements assigned to the first drive and second control elements assigned to the second drive, wherein at least the first control elements are disposed within the machine room.

24. The elevator system of claim 23 wherein the second control elements are disposed within the machine room, within the vertical shaft, or in a room next to the vertical shaft.

25. The elevator system of claim 23 wherein the second control elements comprise operating elements that are disposed in the vertical shaft at a height of a portal.

26. The elevator system of claim 17 wherein the machine room is separated from the vertical shaft by at least one of a floor that can be walked on or a wall.

27. The elevator system of claim 26 wherein a floor of the machine room is configured as a ceiling, a false ceiling, or a grating.

28. The elevator system of claim 16 wherein the second drive is disposed completely in the vertical shaft.

29. The elevator system of claim 16 wherein the second drive has smaller dimensions than the first drive.

30. The elevator system of claim 16 wherein the second drive is disposed in the vertical shaft positioned completely or partially offset to a side in respect of the first car such that the first car is at least movable along part of the second drive.
